(19) United States
(12) Patent Application Publication
(10) Pub. No.: US 2014/0222637 A1
(43) Pub. Date: Aug. 7, 2014

(54) Systems and Methods for Academic Core Banking

(71) Applicant: Samuel K. Giles, Westminster, CO (US)

(72) Inventor: Samuel K. Giles, Westminster, CO (US)

(21) Appl. No.: 13/761,138

(22) Filed: Feb. 6, 2013

(51) Int. Cl. G06Q 40/02

(52) U.S. Cl. CPC G06Q 40/02
USPC 705/35

(57) ABSTRACT

The present invention provides a system, method, and computer program for institutions of higher education to segregate nonexpendable and expendable restricted revenue funds from unrestricted net assets, assess appropriate levels of leverage, determine institutional risk tolerance for fixed and variable-rate debt, and develop sound methodologies to arrive at a predictable blended borrowing rate for all institutional constituents. This insures that all costs to the institution are covered and unexpected fluctuations in financial markets are considered. In addition, the present invention enables greater financial management efficiencies by disentangling and simplifying the patchwork approach of college and university legacy finance and treasury management information systems.

### RELATED APPLICATIONS

This application claims the benefit of, and priority to, the following application: U.S. Provisional Application No. 61/595,451, filed Feb. 6, 2012, entitled “Systems and Methods for Academic Core Banking.”

### BACKGROUND OF INVENTION

1. Field of invention

The present invention relates generally to banking, and more particularly to systems and methods for academic institutional banking.

2. Description of Related Art

Debt once was feared by institutions of higher education; therefore, it was issued only for revenue-producing projects, like undergraduate housing projects. During the past quarter century, however, debt has become an integral component of higher education institutional capital structure and is used to finance a wide range of facilities and, in a number of instances, working capital requirements. While potentially risky, the use of debt can provide significant benefits to an institution if issued, timed, and managed properly, and debt can provide a low-cost source of capital for the institution to accomplish many elements of its mission.

Currently, nearly every institution of higher education in the United States accepts debt as a necessary part of its long-term operating strategy. In fiscal year 2007, for all institutions nationally with $1 billion or more in endowment assets, total debt outstanding exceeded $600 billion.

Many institutions are comfortable with issuing bonds and incurring debt as part of their normal financial structure. Historically, institutions issued debt for specific capital projects, on a project-by-project basis, allocating debt-services costs to the schools, colleges, and academic units to cover the cost of a specific project. In other words, previously institutions would issue debt as needs and capital projects arise.

Presently, many academic institution administration will execute a large bond issuance for the institution based on a long-term capital project strategy, and management will time that issuance to take maximum advantage of the markets. Once the bonds are issued and the institution has the debt in hand, it then can re-loan the funds to institutional borrowers. For example, if the engineering school wishes to erect a new building using some combination of donor funds, cash, and debt, the dean of engineering can borrow the debt from the institutional banking operation on terms that are consistent and at a blended interest rate that all other borrowers also will be charged for debt. If other institutional constituents desire loans, they too could borrow from the bank on the same terms and at the same blended rate.

Another type of academic central bank is to manage cash and liquid, typically non-endowment, assets centrally. At some institutions or in certain higher education systems, individual units or campuses may be permitted to own and manage their own cash. If they believe they will need significant cash on hand for operations, it is likely they will remain overly liquid, thereby foregoing higher interest rates on medium and longer-term investments. This level of liquidity is suboptimal and generally far more conservative than institutional needs would require in order to cover day-to-day expenses. This excess liquidity carries consequences that limit the ability of institutions to optimize the return on their operating investment pool.

Although many institutions are seeking to maximize net operating resources, generate more income and add monetary value to the institution, current systems and methods do not possess means for a highly reliable, scalable institutional banking system solution that offers seamless integration with legacy financial management systems, permits incremental system upgrades, identifies and segregates restricted revenue sources, manages bond issuances, facilitates electronic payments and monitors data security standards.

Multiple, disparate, and aging legacy systems are expensive for institutions to run and inhibit the timely launching of innovative solutions and services. In addition, legacy systems hinder an enterprise-wide view of the institution's constituency network, resulting in poor faculty, staff, student, and department experiences.

Many academic institutions strive to achieve greater competitive advantages and customer service solely by reorganizing their information technology systems or relying on labor arbitrage. However, comprehensive financial management challenges are more systemic, rife with inefficiencies, and unnecessary complexity. Indeed, the key drivers of inefficiency and complexity for academic institutions are outdated technology platforms, inappropriate organizational structures and duplicate business processes. The organization itself, along with its business processes, must be transformed.

### SUMMARY

This Summary is included so as to introduce, in an abbreviated form, various topics to be elaborated upon below in the Detailed Description. This Summary is not intended to identify key or essential aspects of the claimed invention. This Summary is similarly not intended for use as an aid in determining the scope of the claims. The following summary merely presents some concepts of the invention in general form.

One or more aspects describe systems, methods, and computer programs for core banking solutions within institutions of higher education.

At the beginning of 2008, the national landscape for higher education looked bright, albeit with several challenges facing the industry, including issues related to student access, public perception, and the accountability of colleges and universities. At the end of 2008, however, the national landscape dramatically changed with the collapse of financial equity and debt markets, and a resultant credit crisis. The higher education industry, suddenly, was faced with challenges rarely seen before, affecting nearly all of the 4,300 Carnegie-classified institutions of higher education across the Unites States. With little notice in advance of these sudden market failures, asset and debt institutional resources became highly constrained and endowment values plummeted, making cash holdings more valuable than ever.

It has become evident that only those institutions able to manage resources holistically will be able to compete strategically in the crowded marketplace. In addition, it is now no longer an option for institutions of higher education and their senior administration to operate without robust financial management systems to ensure competitiveness. To be competitive in today's higher education global market, institutions must have long-term economic and academic strategies, built upon a foundation of intelligible information technology to ensure effective resource creation combined with equitable and mission-driven resource allocation.

The budget of an institution of higher education remains a complex combination of funds. They include those that flow through it; funds that are restricted in their use; and funds that can be spent on a variety of purposes. These unrestricted funds have emerged as critically important in the effort to shift administrative savings to teaching, research and other mission-driven institutional priorities.

Typically, institutions of higher education will consist of nonexpendable restricted revenue funds, expendable restricted revenue funds and unrestricted net assets. Furthermore, nonexpendable restricted revenue funds are net assets subject to externally imposed requirements that they be maintained permanently by the institution, including funds that are earmarked by the federal and state governments for particular purposes, permanent endowment funds, annuities and other long term funds. Additionally, expendable restricted revenue funds are assets that the institution is obligated to spend in accordance with restrictions imposed by external parties. Generally these restrictions may take the form of scholarships, sponsored research, and department uses. Finally, unrestricted net assets are typically funds not subject to externally imposed restrictions and which may be designated for specific purposes by management or the governing board.

In some embodiments, a system, method, and computer program for institutions of higher education can segregate nonexpendable and expendable restricted revenue funds from unrestricted net assets, assess appropriate levels of leverage, determine institutional risk tolerance for fixed and variable-rate debt, and develop sound methodologies to arrive at a predictable blended borrowing rate for all institutional constituents. This insures that all costs to the institution are covered and unexpected fluctuations in financial markets are considered. In addition, preferred embodiments of a system, method or computer program product for academic core banking can enable greater financial management efficiencies by disentangling and simplifying the patchwork approach of college and university legacy finance and treasury management information systems.

### BRIEF DESCRIPTION OF THE DRAWINGS

FIG. 1—shows the Academic Core Banking System

FIG. 2—shows the academic core banking landscape module

FIG. 3—shows the elements of the academic core banking landscape module not specific to any architectural level

FIG. 4—shows the key elements of the academic core banking landscape module

FIG. 5—shows the elements of a networked academic banking system

FIG. 6—show the elements of academic banking application architecture

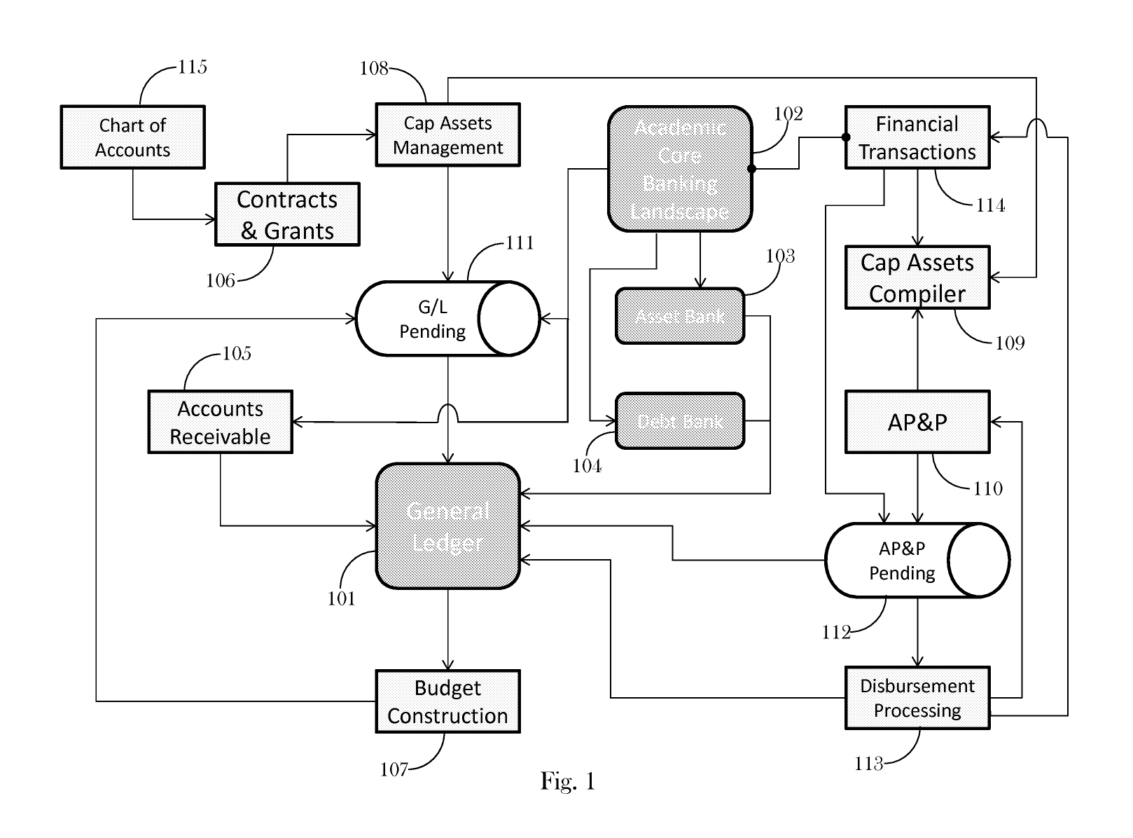

REFERENCE NUMERALS
FIG. 1

| | | | |
|---|---|---|---|
| 101 | General Ledger module | 109 | Capital Assets Compiler module |
| 102 | Academic Core Banking Landscape module | 110 | Accounts Payable module |
| 103 | Asset Bank module | 111 | G/L Pending module |
| 104 | Debt Bank module | 112 | Accounts Payable Pending module |
| 105 | Accounts Receivable module | 113 | Disbursement Processing module |
| 106 | Contracts & Grants module | 114 | Financial Transactions module |
| 107 | Budget Construction module | 115 | Chart of Accounts module |
| 108 | Capital Assets Management module | | |

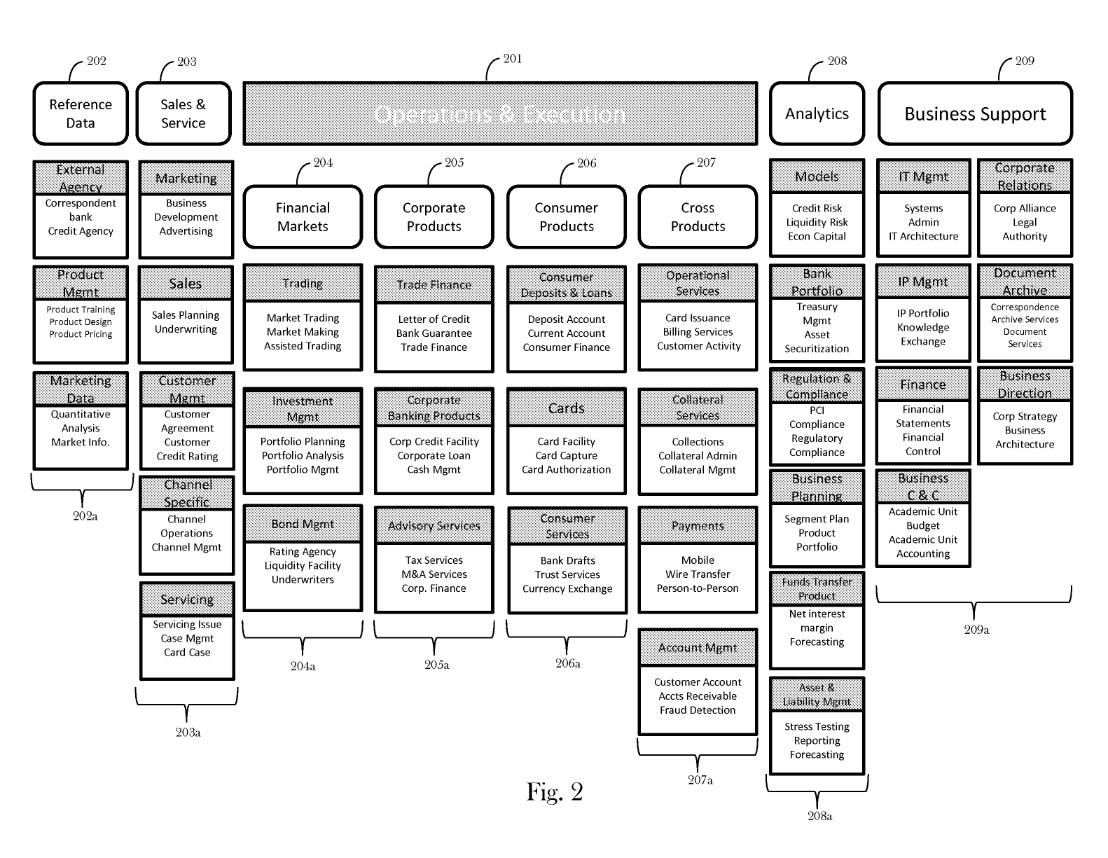

FIG. 2

| | | | |
|---|---|---|---|
| 201 | Operations & Executions Academic Business Area | 201a | Operations & Executions Academic Business Unit |
| 202 | Reference Data Academic Business Area | 202a | Reference Data Academic Business Unit |
| 203 | Sales and Service Academic Business Area | 203a | Sales and Service Academic Business Unit |
| 204 | Financial Markets Academic Business Area | 204a | Financial Markets Academic Business Unit |
| 205 | Corporate Products Academic Business Area | 205a | Corporate Products Academic Business Unit |
| 206 | Customer Products Academic Business Area | 206a | Customer Products Academic Business Unit |
| 207 | Cross Product Operations Academic Business Area | 207a | Cross Product Operations Academic Business Unit |
| 208 | Analytics Academic Business Area | 208a | Analytics Academic Business Unit |
| 209 | Business Support Academic Business Area | 209a | Business Support Academic Business Unit |

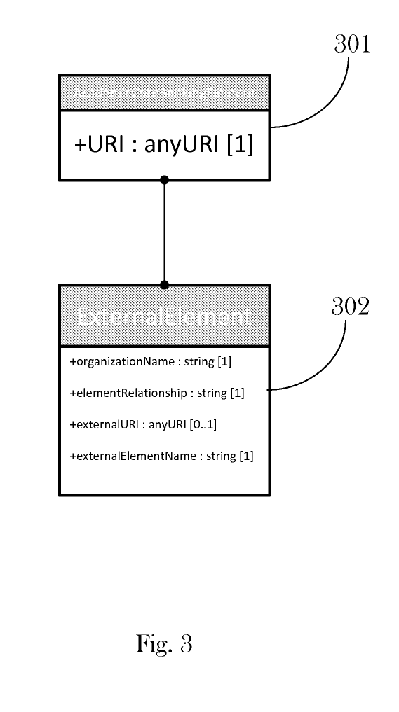

FIG. 3

| | | | |
|---|---|---|---|
| 301 | Academic Core Banking Element | 302 | External Element |

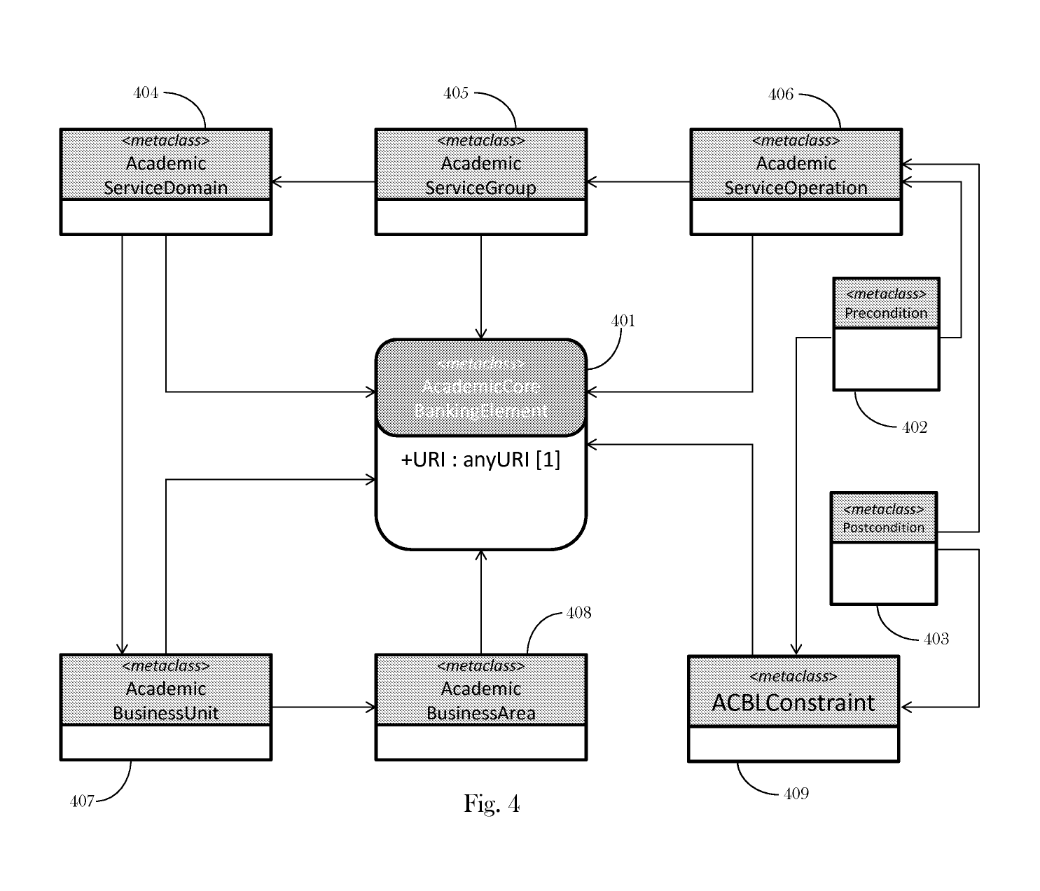

FIG. 4

| | | | |
|---|---|---|---|
| 401 | Academic Core Banking Element | 406 | Academic Service Operation |
| 402 | Precondition | 407 | Academic Business Unit |
| 403 | Post condition | 408 | Academic Business Area |
| 404 | Academic Service Domain | 409 | Academic Core Banking Landscape Constraint |
| 405 | Academic Service Group | | |

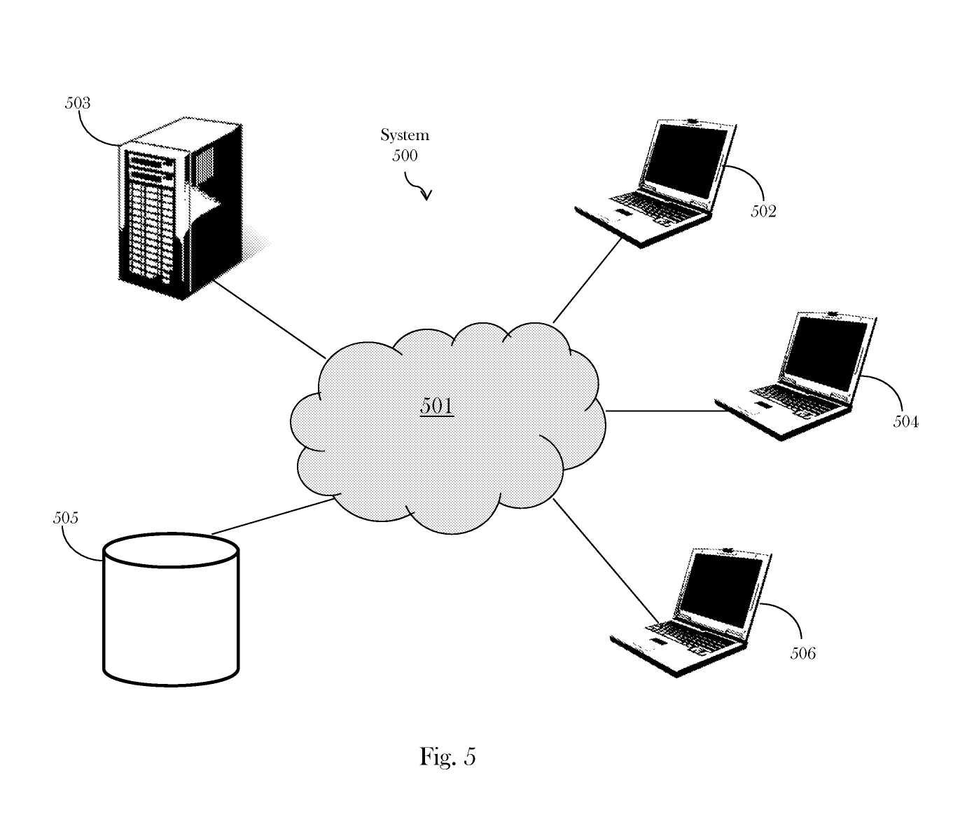

FIG. 5

| | | | |
|---|---|---|---|
| 500 | Academic Banking System | 504 | Client |
| 501 | Network | 505 | Database |
| 502 | Client | 506 | Client |
| 503 | Server | | |

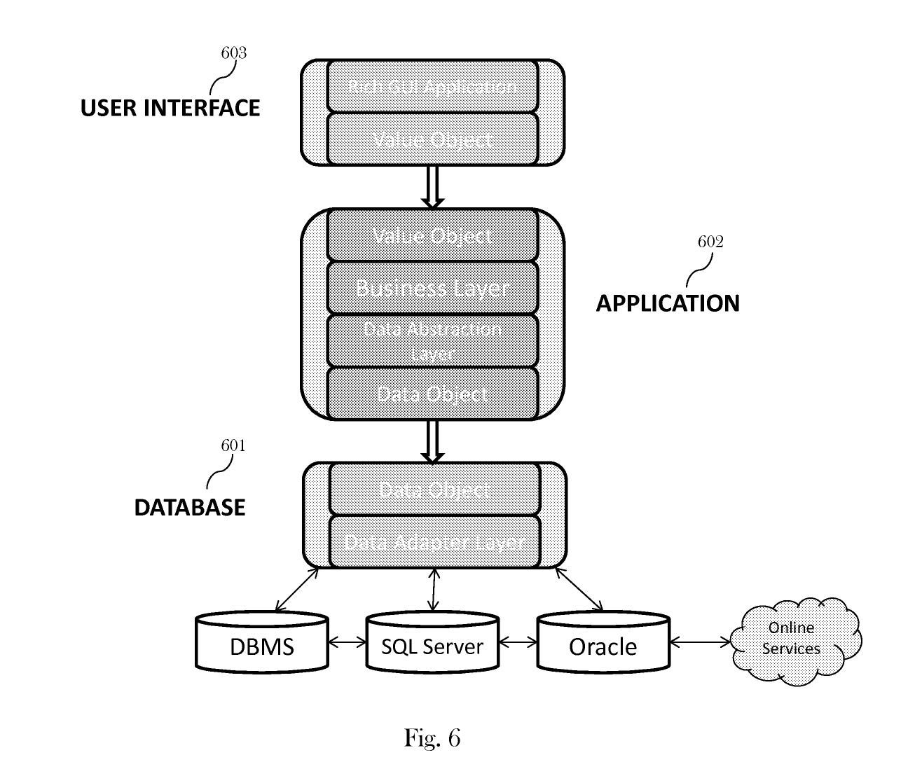

FIG. 6

| | | | |
|---|---|---|---|
| 601 | Database Tier | 603 | User Interface Tier |
| 602 | Application Tier | | |

### DETAILED DESCRIPTION

The preferred embodiment of the present invention is designed to support the distributed nature of universities and colleges. The systems, methods and computer program product for academic banking allows institutions to set up workflows and business rules for different institutional funding groups. One embodiment of the invention is a web-based server system; it allows all authorized users easy, online access, regardless of their location. In addition, the system employs attributes specific to higher education reporting requirements.

The academic banking system routes transaction documents for approval and processing based on business rules established by the institution and the specific organization(s) involved. This customized routing supports both the institution's internal controls and each academic unit's needs to see specific transactions.

Because different institutions have different needs, parameter tables in the academic banking system enable each educational institution to set up institution specific business rules. The subsections below highlight additional features of the system that make it especially well-suited for use in higher education.

The modular design of the present invention includes a base system of a Chart of Accounts 115, General Ledger 101, Financial Transactions 114, Reporting, Accounts Payable 114, and Academic Core Banking 102. Additional modules can be implemented when the institution identifies a need. Furthermore, the present invention can build and deploy a variety of applications rapidly, with enterprise consistency and reliability, coupled with best-of-breed flexibility.

### FIG. 1—Budget & Finance

FIG. 1 shows the functions of an Academic Core Banking System. Higher education accounting requires that income/revenues and expenses/expenditures be grouped by sources of funds. The source of funds indicates the revenues/expenditures that are allowed on a particular account. Reporting requirements and approvals differ for each funding source. The present invention allows institutions to segregate funding sources into fund groups and sub-funds and then allows the institution to set up business rules and workflow appropriate to each. So, for example, this approach allows contracts and grants fund groups to be subject to the specific rules of their sponsors.

Typically, sources of funds carry restrictions. In the preferred embodiment of the present invention, restrictions are specified for each sub-fund by setting a “restricted” status code. Then, when a user creates a new account and associates it with the restricted sub-fund, the restricted status code is automatically applied to the account. This insures that only unrestricted funds have access to be transferred to the academic core banking landscape 102.

Furthermore, FIG. 1 displays the restricted status code classifies the funds as restricted, unrestricted, or temporarily restricted. The sub-fund group code identifies the minor fund group for an account. Each sub-fund group belongs to a fund group that defines the source of funds. Both fund groups and sub-fund groups are defined by each institution to fit its needs. For example, an institution can set up contracts and grants as a sub-fund group reporting to a restricted fund group.

### FIG. 1—Procurement

As illustrated by FIG. 1, the institution's organizational structure serves as the backbone for the Chart of Accounts module 115 and for reporting and routing in the academic core banking system. With procurement proceedings, the current invention implements a comprehensive requisitioning, purchasing and accounts payable module for institutions of higher education.

Research intensive colleges and universities require extensive effort tracking and reporting for grant and contract related activities. To accommodate this need, the present invention incorporates a Contracts and Grants module 106 that captures appropriate payroll data for contracts and grants. Complete support of contracts and grants is a key objective. System features will include the ability to automatically create an account in the system when an award is received.

In some embodiments, the Contracts and Grants module 106 can be mapped to the Chart of Accounts module 115 for post award processing including indirect cost recovery rate, type, and accounts. In addition, the Contracts and Grants module 106 can be mapped to the Capital Assets module 108.

### FIG. 1—Disbursement Processing

The current invention also provides a means for disbursement processing. In order to ensure that credit memos are accounted for in vendor payments, payment requests and credit memos are bundled in the Accounts Payable module 110. An Accounts Payable Pending module 112 saves real time entries before feeding the entries to The Disbursement Processing module 113.

As indicated by FIG. 1, in one embodiment, the Disbursement Processing module 113 then extracts the bundled payment requests and disbursement vouchers for payment and formatting. Once in Disbursement Processing module 113, payments may be canceled, held, or set for immediate processing. In support of these activities, the module creates check, check cancel, mobile, person-to-person and ACH XML files.

In addition, the current invention incorporates an Accounts Receivable module 105 to allow academic units to electronically invoice external customers for goods or services. Payments received for these goods or services are processed by a centralized unit.

### FIG. 1—Capital Asset Compiler

An embodiment of the invention permits electronic document routing to ensure that each requisition has been reviewed and approved by users who have fiscal responsibility for the request. Asset information on the requisition and the financial processing electronic documents is then passed into the Capital Asset Compiler 109, where the asset is created. When payment requests are posted to the General Ledger 101, the system posts the capitalization entries to the plant accounts associated with the account on the line item.

Furthermore, as illustrated by FIG. 1, when payment requests are processed on the purchase order for one or more capital assets, the appropriate items are picked up by the system's Capital Asset Compiler 109. The Capital Asset Compiler 109 also picks up transactions from other financial processing electronic documents. Authorized users can then process these electronic documents in the General Ledger 101. Finally, asset information in the Financial Transactions module 114 is captured by the Capital Asset Compiler 109.

### FIG. 1—Capital Asset Management

FIG. 1 also displays an embodiment of the current invention permits the Capital Asset Management module 108 to support many asset related activities, including editing asset information, updating information on equipment loans and loan extensions, merging and separating assets, fabricating assets, and transferring assets from one organization to another. Furthermore, the Accounts Payable module 110 and the Capital Asset Management module 108 are mapped to the Capital Asset Compiler 109 process in order to pull pre-assets from payment requests.

A preferred embodiment of the present invention employs a General Ledger module 101 that can be mapped to the Financial Transactions module 114 that send real-time entries to the GL Pending module 111 and employs arithmetic logic circuits configured to retrieve information from specific files, calculate incremental modifications based on specific input, allocate the results and store the output in separate files. In addition, the General Ledger module 101 can be mapped to the Accounts Payable Pending module 110 to send real-time entries for purchase orders and payment requests to the GL Pending module 111 for establishing encumbrances and liquidating encumbrances. Furthermore, the General Ledger module 101 can be mapped to a labor distribution module to create a batch file of general ledger transactions that is processed by the General Ledger module 101.

The General Ledger module 101 can map to the Capital Asset Management module 108 to save pending entries into the General Ledger module 101. Moreover, the General Ledger module 101 can be mapped to the Disbursement Processing module 113 to send pending entries to record general ledger transactions. Lastly, the General Ledger module 101 can be mapped to the Budget Construction module 107 to extract budget information from the General Ledger 101 for use in preparing budgets for a new year.

### FIG. 1—Academic Core Banking Landscape

In the preferred embodiment of the academic banking system, it contains an Academic Core Banking Landscape (ACBL) module 102 to facilitate the financial transactions of the academic institution. This module employs arithmetic logic circuits configured to retrieve information from specific files, calculate incremental modifications based on specific input, allocate the results and store the output in separate files. Also, said ACBL module 102 maximizes net interest margins, creates reserves of unrestricted net assets, facilitates mobile and person-to-person payments, serves as a means for displaying capital and liquidity metrics, improving institutional cash flows, and systematically lowers the cost of capital for the institution by optimizing access to credit markets.

In addition, FIG. 1 displays the ACBL module 102 is mapped to Debt Bank 104 and Asset Bank 103 interfaces based on arithmetic logic circuits configured to retrieve information from a specific file, calculate incremental modifications based on specific input, allocate the results and store the output in a separate file. The Debt Bank interface 104 facilitates institutional bond issuance processes, establishes blended interest rates for borrowers and re-loans bond funding. Furthermore, said ACBL module 102 is also mapped to the Asset Bank interface 103 where the Asset Bank interface 103 manages liquidity across the institution. Moreover, said ACBL module 102 pools institutional working capital, establishes blended interest rates for depositors, and invests reserves in capital markets.

### FIG. 2—Reference Data Academic Business Area

FIG. 2 details an overall view of a preferred embodiment of the present invention, including an Operations & Execution Academic Business Area 201. Said Operations & Execution Academic Business Area 201 includes the full range of product fulfillment activities for academic and retail banking, including shared operational capabilities and all front, middle and back office activities.

The area Reference Data Academic Business Area 202 contains all categories of managed business information, covering customer details, business partners, product details that is widely accessed across other activities. Within the Reference Data Academic Business Area 202, the External Agency Academic Business Unit 202a facilitates transactions and correspondence with external agencies. The Product service agent Academic Service Domain maintains contractual and service agreements with transaction related service providers.

In addition, FIG. 2 shows an exemplary Syndicate Academic Service Domain that handles the management, reporting and coordination of syndicates that an institution might create and administer to support certain financial transactions. Finally, the Correspondent Academic Service Domain administers the agreement and reciprocity arrangements, consolidation and reporting for correspondent institutions.

According to another embodiment, the Reference Data Academic Business Area 202 also contains a Marketing Data Academic Business Unit 202a that covers all market information related activity. Within said Academic Business Unit 202a, a Credit agency Academic Service Domain handles the operation of the subscribed credit rating agency service, supporting service based access to individual's credit profile for any internal service center. It is mapped in the Reference area as Market Data.

Also, a Financial market Academic Service Domain addresses specific financial market research as might be used to define and influence investment strategies. This capability combines repeated analyses of standard aspects of financial markets and ad hoc/targeted analysis of specific events or trends. Said service domain may be expanded to analyze available sources of internal and external financial market information to develop insights and opinions on any aspect of market activity and pricing.

Furthermore, as illustrated in FIG. 2, a Market info Academic Service Domain can maintain/scrub/qualify/archive market information to provide structured/enhance information/history. This academic service domain supports an internal market data function to assemble, scrub, enhance and present market data. Some institutions will simply pass through external feeds as are others capture and improve the data.

The Reference Data Business Area can also contains a Product Management Academic Business Unit that includes many candidate service domain that cover all product categories and include the design and development activities and bundling for all products.

Concurring with one embodiment, within said Academic Business Unit 202a, a Product design Academic Service Domain maintains and refines product specifications in response to product usage, servicing and profitability details and external market and competitor insights. In addition, a Product deployment Academic Service Domain plans and administers the deployment activities for new and enhanced products, includes training, inventory and solution deployment and coordination with marketing and sales activities. Lastly, a Product pricing Academic Service Domain maintains a current price list—note this supports variable pricing to reflect demand generation and other marketing/sales strategies. It can result in price changes over and above the standard pricing models defined as part of product design.

### FIG. 2—Sales and Service Academic Business Area

FIG. 2 displays the Sales and Service Academic Business Area 203 that covers all marketing, business development, sales and servicing activities. It excludes the fulfillment activities associated with enforcing product delivery but includes all agreement related activities.

For example, as described herein, within said Academic Business Area, an exemplary Channel specific Academic Business Unit 203a includes a mixture of existing Academic Service Domains aimed at supporting all channels and the associated interactions with customers. Also, according to another embodiment, a Channel management Academic Service Domain is a department specific interpretation of department layout design and policies where desk based and administration services are assigned and traffic is targeted. It is an important function for department/product optimization. A Channel operations Academic Service Domain operates the day to day activity within the department or academic unit, allocate staff and business managers to positions, and track availability/performance metrics.

FIG. 2 shows a Marketing Academic Service Domain supports planning as well as management and execution of marketing campaigns while a Business development Academic Service Domain evaluates new business development activity and create/update plan for all types of campaigns. An Advertising Academic Service Domain manages budgets that can be large and often need significant coordination across the different product/service lines of business. This function addresses the advertising budget and execution.

In addition, according to one embodiment, the Sales Academic Business Unit 203a covers all aspects of sales planning, offers, and sales support. It includes service domains handling relationship planning that could merit their own domain as they cover more than just sales activity. As for underwriting, there is an Underwriting Academic Service Domain to manage the underwriting decision process and levels of authorization for loans. The Sales planning Academic Service Domain is intended to handle the oversight of the sales resources, developing sales plans, targets and directing resources for the best effect. Also, a Customer Management Academic Service Domain covers the range of customer management activities.

Furthermore, as depicted in FIG. 2, a Customer agreement Academic Service Domain maintains structured legal agreements for institutional constituents, note that this can include a nested hierarchy for more complex customer types and different sub set specializations of the agreement, such as payment agreement terms. A Customer credit rating Academic Service Domain maintains and administers the credit scoring for institutional constituents based on consolidated internal data and external credit agency insights.

A Servicing Academic Business Unit 203a handles all non-sales-directed customer or prospect customer requests, while a Customer care Academic Service Domain initiates, tracks, resolves and reports on customer cases that typically require corrective response to some financial transaction. Lastly, a Credit case Academic Service Domain captures, tracks, resolves and reports on card related transactional disputes.

### FIG. 2—Customer Products Academic Business Area

Additionally, FIG. 2 show an exemplary Customer Products Academic Business Area 206 that includes a full range of product fulfillment activities for wholesale and retail banking, including shared operational capabilities and all front, middle and back office activities. According to one embodiment of the present invention, within said Customer Products Academic Business Area 206, a Customer loans Academic Business Unit 206a efficiently and effectively develop and deployment a range of academic banking loan products. A Secured loan Academic Service Domain facilitates a range of secured loan products/instruments while the Unsecured loan Academic Service Domain facilitates a range of unsecured loan products/instruments. In addition, a Deposit account Academic Service Domain orchestrates different flavors of consumer deposit account (savings, term or demand) products including services and fees.

For example, in an embodiment, said Customer Products Academic Business Area 206, a Cards Academic Business Unit 206a handles the card transactions issued through the institution. A Card facility Academic Service Domain orchestrates the scheduled and transactional activities associated with card product fulfillment. Also, a Card capture Academic Service Domain captures the card payment transaction through the merchant network. Finally, a Authorization Academic Service Domain executes the decision based authorization and recording of proposed card transactions through the merchant network.

Additionally, within the Customer Products Academic Business Area 206, a Customer service Academic Business Unit 206a facilitates iterations with customer relations. A Bank drafts Academic Service Domain administers the pricing, recording and generation of Bank Drafts and T.Checks. Finally, a Customer investments Academic Service Domain handles the consumer front end trading requests.

### FIG. 2—Financial Markets Academic Business Area

Furthermore, FIG. 2 shows a view of one embodiment of the present invention, the Financial Markets Academic Business Area 204 includes a full range of financial market activities for front, middle or back office activities. Within said Financial markets Academic Business Area 204 an Investment management Academic Business Unit 204a brings together all facets of consumer investment activity.

An Investment portfolio Academic Service Domain solidifies the customer portfolio principles, guidelines and profile and ensures disclosure and related obligations are made. Also, an Investment portfolio analysis Academic Service Domain assesses and reports on investment portfolio make-up, valuation and performance. Finally, an Investment management Academic Service Domain orchestrates the investment/rebalancing of an investment portfolio to optimize gains within the portfolio charter.

Also, according to one embodiment, FIG. 2 shows the Financial Markets Academic Business Area 204, a Trading Academic Business Unit 204a designed to house all whole sale front office activity. A Market making Academic Service Domain orchestrates the market making activity of a security. In addition, a Trade making Academic Service Domain contains the general capability to trade a position in the wholesale markets. This involves the consolidation of related transactions that contribute to the position and the subsequent wholesale market activity to manage the position. Finally, an Assisted trading Academic Service Domain supports customer assisted trading, where an institutional constituent can instruct deals within the terms and constraints of an agreement.

Furthermore, in another embodiment of the present invention, a Bond Management Academic Business Unit 204a includes a full range of bond market activities for front, middle or back office activities. A Rating agency Academic Service Domain maintains strong relationships with rating analysts and facilitates open lines of communication. An Underwriting Academic Service Domain purchases bonds from an issuer with intent to resell the bonds to investors. This module is used to facilitate negotiations for bond transactions.

In addition, FIG. 2 shows a Liquidity facility Academic Service Domain letter of credit issued by a bank and the trustee draws on the letter of credit to make debt service payments, which the issuer later reimburses to them. Liquidity is a standby obligation of a bank to make debt service payments if the issuer fails to do so. Finally, a Trustee Academic Service Domain establishes and maintains funds relating to the bond issue, pays the bondholders, and protects the interest of the bondholders by monitoring compliance of the covenants.

### FIG. 2—Corporate Products Academic Business Area

Moreover, FIG. 2 shows a view from one embodiment, the Corporate Products Academic Business Area 205 that includes a full range of corporate products activities for front, middle or back office activities. A Trade Finance Academic Business Unit 205a provides all mechanisms for trading financial instruments. A Letter of credit Academic Service Domain handles the pricing and issuance of a letter of credit, typically associated with corporate trading activity supported by a trade finance line of credit. In alternative embodiments, there can be significant activity associated with trading letters of credit that can be modeled as an instrument handled by existing trading service domains or a specialized activity with it own service domains.

Furthermore, a Bank guarantee Academic Service Domain orchestrates the pricing and issuance of Bank Guarantees for corporate/correspondent trade and project finance activity. Finally, a Trade finance services Academic Service Domain collects services associated with the support of international trade finance (including the coordination of correspondent banks, shipping, customs, lading, warehouse activity) alongside financial management.

According to another embodiment, Within the Corporate Products Academic Business Area 205, an exemplary Corporate Banking Products Academic Business Unit 205a provides all mechanisms for supporting corporate banking products. A Corporate credit facility Academic Service Domain maintains the availability and allocation of a negotiated credit line or facility for a corporate customer, including subsidiary allocations where appropriate. A Corporate loan Academic Service Domain orchestrates the initiation, processing and conclusion of any type of corporate fixed term loan.

Also, a Cash management Academic Service Domain orchestrates the range of Cash Management services available for agencies (includes cash handling, account reconciliation, cash concentration, ACH, Positive and Reverse Positive Pay, Sweep and Wire services).

For example, FIG. 2 shows the Corporate Products Academic Business Area 205 and Corporate Financing & Advisory Services Academic Business Unit 205a that handles a range of corporate financing and advisory services. In a preferred embodiment, a Tax services Academic Service Domain provides the range of cross account services such as withholding tax commitments. A Corporate finance service Academic Service Domain assigns a fee or commission based project providing specialized financing advice (tactical and strategic) to a corporation.

In addition, a Corporate Tax advisory Academic Service Domain handles a fee based advisory service to support tax advice and optimization for corporate clients, including international tax liability distribution and booking optimization services. Finally, A M&A advisory services Academic Service Domain assigns a fee or commission based project providing execution, pricing and deal coordination and placement for M&A, IPO, LBO type transactions.

### FIG. 2—Cross Product Operations Academic Business Area

Moreover, FIG. 2 shows a view from an embodiment, the Cross Product Operations Academic Business Area 207 includes a full range of cross products for front, middle or back relations. A Payments Academic Business Unit 207a handles all activities associated with payments. A Mobile payments Academic Service Domain processes electronic mobile transactions, person-to-person payments, and creates payment transaction records stream.

For example, FIG. 2 displays an exemplary Cross Product Operations Academic Business 207 and Payments Business Unit 207a that facilitate all activities associated with payments. Additionally, a Wire transfer Academic Service Domain operates automated message interfaces to secure networks such as SWIFT, TELEX, ACH and Exchange reporting services. Finally, according to the preferred embodiment, a Person-to-Person Academic Service Domain manages the electronic commerce services that permits payments, utilizing a recipient's email address, mobile phone number or bank account information to facilitate transactions.

Within the Cross Product Operation Academic Business Area 207, a Collateral administration Academic Business Unit 207a handles all activities associated with risk management. A Collections Academic Service Domain handles the recovery of distressed accounts. This is post any attempt to recover the account and involves the realization of collateral against failed accounts. Also, a Collateral asset Academic Service Domain maintains the status of a collateral item include schedules and ad-hoc valuation and confirmation of scheduled maintenance tasks. Furthermore, a Collateral management Academic Service Domain administers collateral holdings for a customer, orchestrating their allocation, utilization reporting, periodic valuation and administration.

Additionally, FIG. 2 shows an Account Management Academic Business Unit 207a that handles the range of general account management facilities. A Customer account Academic Service Domain administers the financial postings for a base customer account, including generic accounting services such as calendar based interest calculations. An Accounts receivable Academic Service Domain manages the tracking, chasing and receipt of scheduled payments against issued invoices. A Fraud detection Academic Service Domain executes fraud behavior patter scanners and threshold based transaction triggering of possible fraudulent/AML activity.

In another embodiment, as now described, an Operational Services Academic Business Unit 207a covers the range of shared operational services. A Card issuance Academic Service Domain administers and tracks the status of cards issued to customers, including card cancellation and smart card tracking. In addition, a Consolidate customer activity Academic Service Domain consolidates product transaction details to provide an integrated position or reports on activity. Also support the wrapping and blocking of products for multiple customers. Finally, a Billing services Academic Service Domain provides central services to compose and issues billing and invoices.

### FIG. 2—Analytics Academic Business Area

FIG. 2 continues to show a view of an embodiment of the present invention, the Analytics Academic Business Area 208 covers all activities that involve analysis of performance and risk. It is proposed the service domains are partitioned into domains corresponding to distinct types of analysis. An Asset/Liability Management Academic Business Unit handles all aspects of balance sheet management.

For example, a Stress testing Academic Service Domain can stress-test balance sheets for sudden and significant movements in interest rates. In addition to standard scenarios, stress scenarios can be defined and processed allowing evaluation of projected income, valuation, capital and liquidity metrics under both expected and unexpected circumstances.

A Reporting Academic Service Domain provides a number of reporting formats including proforma financial statements; comparative reports and analysis; decision graphics; market valuation/duration reports; integrated market value reporting for FAS 107 and FAS 115; simulation audit reports and account details; and static and dynamic gap reports. In one embodiment, a Forecasting Academic Service Domain affords forecasting capabilities for short term and long term horizons. In addition, it can store budget and actual data for variance, rate/volume and trend analysis, so it is easy to evaluate new strategies against committed plans.

According to one embodiment, within said Analytics Academic Business Area 208, a Funds Transfer Pricing Academic Business Unit 208a accurately measures the net-interest margin by reflecting the economic characteristics of each customer account and instrument. The system avoids the built-in limitations and inaccuracies of a simple pool-based approach and provides a comprehensive set of allocation techniques.

FIG. 2 highlights a Net interest margin Academic Service Domain provides the missing component to a business unit's net interest margin. In a line-of-business reporting environment where business units do not necessarily have traditional balanced balance sheets and income statements, it is necessary to fund assets and liabilities from an institutional treasury function.

According to another embodiment of the present invention, a Reporting Academic Service Domain reports supports decision-making and analyzes net-interest margin at any organizational and product level. Standard reports include, but not limited to, current process reporting, variance reporting, funding center reporting, as well as exception and account level reports. A batch-processing feature allows all processes, including reporting, to be grouped together and run at one time.

Furthermore, within said Analytics Academic Business Area 208, an exemplary Forecasting Academic Service Domain analyzes net-interest margin of each financial instrument and/or product under a variety of rate, balance sheet and other assumption driven scenarios. Specifically, forecast funding sources, or risk position of the institution, determine how the funding sources results impact and/or correlate to overall institution performance. It utilizes a series of margin, funding sources and gap reporting capabilities to analyze an institution from a whole new perspective, encompassing both historical performance and forecasted scenarios at the institution and/or product level.

According to one embodiment, as now illustrated, a Bank Portfolio & Treasury Academic Business Unit 208a draws together the central treasury and portfolio activities. A Treasury management Academic Service Domain tracks the consolidated treasury positions for the institution and initiate intra-institution and market trades and hedging as needed to remain within desired boundaries. A Treasury admin Academic Service Domain orchestrates the consolidation and presentation of detailed summary transactions in order to assemble a timely and accurate view of the overall treasury position of the institution at any one time.

Furthermore, FIG. 2 shows said Analytics Academic Business Area 208 and an Asset securitization Academic Services Domain that determines and selects assets for securitization as needed to maintain and optimize the institution's portfolio. This financial function interprets institutional portfolio/asset and liability policies and reviews the institution's books for instrument positions that are eligible for securitization, initiating securitization where necessary.

A Models Endeavors Academic Business Unit 208a contains all activities relevant risk, accounting, controlling, compliance and marketing analysis. A Liquidity risk Academic Service Domain develops and maintains models for dispositive and structural liquidity risk management, including liquidity gap analysis, Liquidity at Risk and Liquidity Value at Risk.

FIG. 2 also shows a Credit risk Academic Service Domain that develops and maintains models for counterparty, issuer, and portfolio risk for all contracts, instruments and portfolios respectively. In another embodiment, an Econ capital Academic Service Domain supports the analysis and management of cross-risk type risk, including aggregation methods like correlation based aggregation and copula techniques. Lastly, a Market risk Academic Service Domain develops and maintains a portfolio of market risk models including currency, interest rate, instrument quotes, indices, commodity prices and other market and macroeconomic risk factors.

Furthermore, according to one embodiment within said Analytics Academic Business Area 208, a Business Planning Academic Business Unit 208a brings together a range of enterprise and divisional analysis activities. A Segment plan Academic Service Domain defines market segments and develop and assess performance against the segment plan performance goals. A Product portfolio Academic Service Domain maintains and assesses coverage and relative performance/profitability of the full range of offered products and product combinations/bundles.

Also, according to another embodiment of the present invention within said Analytics Academic Business Area 208 of FIG. 2, a Regulations & Compliance Academic Business Unit 208a brings together the collection of regulatory reporting and compliance activities. A Payment Card Industry Data Security Standard compliance Academic Service Domain monitors and maintains regulatory compliance with payment card industry. In addition, a Regulatory compliance Academic Service Domain consolidates, assesses and reports on production and operational activity and transactions as necessary to meet regular and ad hoc regulatory reporting needs.

### FIG. 2—Business Support Academic Business Area

FIG. 2 displays another perspective of an embodiment of the present invention, a Business Support Academic Business Area 209 spans a wide range of business management and support activities. An IT management Academic Business Unit 209a consolidates all systems related activities. A System admin Academic Service Domain administers the licensing, maintenance commitments, assignment and usage status of IT assets. In addition, an IT architecture Academic Service Domain develops, maintains and enforces comprehensive IT architectures and standards as appropriate to optimize the performance and return on IT related investments. A System development Academic Service Domain is responsible for the oversight and execution of all technology development activity, including all scales of development projects and production support and assurance activities.

Moreover, within said Business Support Academic Business Area 209, an exemplary Finance Academic Business Unit 209a handles the central financial control and reprinting activities of the institution. A Financial statements Academic Service Domain consolidates and presents the enterprise financial statements: this includes the balance sheet, statement of cash flows, statement of retained earnings and the income statement. A Financial control Academic Service Domain reviews and confirms the correct booking and conformance of financial activity to agreed budgets and procedures. In addition, provides specialist advice and undertakes initiatives as necessary to ensure the correct financial accounting of activity across all business units.

Furthermore, FIG. 2 shows a Business command & control Academic Business Unit 209a contains the repeating capability that implements the command and control hierarchies of the enterprise. An Academic unit budget Academic Service Domain defines and maintains the business unit operating budget. An Academic unit accounting Academic Service Domain administers the business unit sub ledger, reconciling accounting entries as necessary a reporting consolidated financial reports to the enterprise general ledger as required.

According to another embodiment, within said Business Support Academic Business Area 209, a Knowledge & IP Management Academic Business Unit 209a handles all aspects of intellectual property (IP) management and administration. An IP portfolio Academic Service Domain administers the consolidated portfolio of intellectual property, ensuring entitlement and associated patent or copyright mechanisms are adopted and enforced. In addition, it leverages IP through licensing as appropriate. A Knowledge exchange Academic Service Domain consolidates, classifies and provides structured access to collective market, product and procedural knowledge gained from the workforce in the execution of business to support continual improvement.

Within the Business Support Academic Business Area 209, a Corporate Relations Academic Business Unit 209a facilitates all elements of relationship building between the institution and its outside constituents. A Corporate alliance Academic Service Domain manages key alliance and stake holder relationships and also defines tasks needed to develop and maintain contact and ensure relevant information is shared as appropriate. A Regulatory & Legal Academic Service Domain maintains effective relations with regulators, accounting and government agencies and oversees interactions and reporting as necessary.

As depicted in FIG. 2, according to another embodiment of the present invention, an University Direction Academic Business Unit 209a handles all aspects of business processes, architecture and correspondence. An University strategy Academic Service Domain defines and communicates the university strategy and plan. In addition, it directs business activity to meet, refine and improve the institution goals and approaches. Furthermore, a Business architecture Academic Service Domain handles the specification and maintenance of the enterprise business architecture. This reflects the business priorities set out in the corporate strategy and the organization as defined in the organizational model. It provides a basis for defining performance goals and budgets and can be a high level blueprint for systems and operational implementation.

Finally, in another embodiment, a Document management & archive Academic Business Unit 209a is responsible to track and store electronic documents and/or images of paper documents for all other Domains. A Document services Academic Service Domain handles the full life cycle handling of all media type documentation, typically to support electronic storage, retrieval and distribution of important documentation. It includes archiving capabilities of electronic and any hard copy materials as needed. An Archive services Academic Service Domain provides long term archiving and retrieval services for documents and electronic media. A Correspondence Academic Service Domain orchestrates the production of pre-formatted correspondence and batches of correspondence.

### FIG. 3—Academic Core Banking Landscape

In one embodiment, as will now be described, FIG. 3 shows the elements of the AcademicCoreBankingLandscape 102 that are not specific to any of the architectural levels. All elements of the AcademicCoreBankingLandscape 102 inherit from the abstract class AcademicCoreBankingElement 301; thus all elements have universal resource identifiers and can be associated with elements defined in external repositories.

This abstract class is at the top of the Academic CoreBankingLandscape 102 inheritance hierarchy. Thus, all AcademicCoreBankingElements 301 have universal resource identifiers and can be associated with AcademicCoreBankingElements 301 defined in external repositories.

### FIG. 3—External Related Element

In one embodiment, as will now be described, an External Element 302 that is defined outside of Academic Core Banking System but is relevant to a AcademicCoreBankingElement 301. The External Element 302 is related to the AcademicCoreBankingElement 301.

### FIG. 4—Academic Business Area

FIG. 4 shows an overall view of a preferred embodiment present invention, an Academic Business Area 408 is formed by a broad set of capabilities and responsibilities and lies at the highest level of the core banking service landscape hierarchy. The Academic Business Areas 408 are used to decompose financial functions of higher education institutions. Also, the general category of Academic Service Domain 404 possesses a distinct property in terms of their business role/ownership, the operational characteristics/behaviors or architectural features.

### FIG. 4—Academic Business Unit

In one embodiment, as will now be described, an Academic Business Unit 407 falls within the Academic Business Area 408. The association is a composition in which Academic Business Area plays the role of composite and Academic Business Unit 407 plays the role of component. In a related collection of Academic Service Domains, wholly within an Academic Business Area 408, are typically associated with some easily recognized technical/architectural, functional or operational characteristics.

### FIG. 4—Academic Service Domain

According to another embodiment, FIG. 4 shows an Academic Service Domain 404 is an element of the functional decomposition of the banking business functions in the context of the Academic Core Banking Landscape 102. Academic Service Domains 404 are linked to certain skills and knowledge, which are clearly identifiable in traditional banking operations. In addition, an AcademicBusinessDomain belongs to exactly one AcademicBusinessArea and AcademicBusinessDomains are part of the Academic Core Banking Landscape 102.

### FIG. 4—ACBL Constraint

AcademicCoreBankingLandscape (ACBL) Constraint 409 is a specialization of ISO20022 Constraint. In addition, it is a subclass of Academic Core Banking Element 401, and thus inherits additional properties from this superclass.

### FIG. 4—PostCondition

As illustrated in FIG. 4, a Postcondition 403, mapped to an AcademicServiceOperation 406, specifies a condition of the system that must be true at the time when the AcademicServiceOperation 406 has completed executing. It is distinct from a Precondition, which is a condition that must be true when the AcademicServiceOperation 406 is executed.

Furthermore, in one embodiment, a Postcondition is a subclass of ACBL Constraint 409 and are typically expressed in terms of the business objects that are involved in the execution of the AcademicServiceOperation 406. The association is a composition in which AcademicServiceOperation 406 plays the role of composite and Postcondition 403 plays the role of component.

### FIG. 4—PreCondition

A Precondition 402 of an AcademicServiceOperation 406 specifies a condition of the system that has to be true at the time when the AcademicServiceOperation 406 is called in order for the behavior of the AcademicServiceOperation 406 to be well defined. It is distinct from a Postcondition 403, which must be true after an AcademicServiceOperation 406 has been executed successfully.

Additionally, in an embodiment, a Precondition 402 is a subclass of an ABCL Constraint 409 and is typically expressed in terms of the business objects that are involved in the execution of the AcademicServiceOperation 406. The association is a composition in which AcademicServiceOperation 406 plays the role of composite and Precondition 402 plays the role of component.

### FIG. 4—AcademicServiceGroup

According to another embodiment of the present invention, FIG. 4 shows an AcademicServiceGroup 405 is a set of AcademicServiceOperations 406, and is owned by an AcademicServiceDomain 404. In essence, it is an interface to the AcademicServiceDomain 404 that can be defined in terms of business semantics rather than in technical IT terms.

Furthermore, the AcademicServiceDomain 404 is obligated to provide the AcademicServiceGroup's 405 AcademicServiceOperations 406. The association is a composition in which AcademicServiceDomain 404 plays the role of composite and AcademicServiceGroup 405 plays the role of component.

### FIG. 4—AcademicServiceOperation

In one embodiment, as will now be described, an AcademicServiceOperation 406 represents a service defined at the level of business semantics, specifying the access to one or more capabilities of a AcademicServiceDomain 404. Also, AcademicServiceOperations 406 are grouped into AcademicServiceGroups 405. The association is a composition in which AcademicServiceGroup 405 plays the role of composite and AcademicServiceOperation 406 plays the role of component.

### FIG. 5—Networked Academic Banking System

With reference now to the figures, and in particular with reference to FIG. 5, a pictorial representation of a distributed academic banking system in which the present invention may be implemented is depicted.

FIG. 5 shows an overall view of an embodiment present invention, an academic banking system 500 is a network of computers in which the present invention may be implemented. Distributed academic banking system 500 contains a network 501, which is the medium used to provide communications links between various devices and computers connected together within distributed academic banking system 500.

A “computer” may refer to an apparatus or system capable of accepting a structured input, processing the structured input according to prescribed rules, and producing results of the processing as output. Examples of a computer may include: a stationary computer; a portable computer; application specific hardware to emulate a computer and/or software; and an apparatus that may accept data, may process data in accordance with one or more stored software programs, may generate results, and typically may include input, output, storage, arithmetic, logic, and control units.

In one embodiment, as will now be described, network 501 may refer to a number of computers and associated devices that may be connected by communication facilities. Network 501 may involve permanent connections such as cables or temporary connections such as those that may be made through telephone or other communication links. Network 501 may further include hard-wired connections and/or wireless connections. Examples of a network may include: an internet, such as the Internet: an intranet; a local area network (LAN); a wide area network (WAN); and a combination of networks, such as an internet and an intranet.

In the depicted example, a server 503 is connected to network 501 along with database 505. In addition, clients 502, 504, and 506 also are connected to a network 501. These clients 502, 504, and 506 may be, for example, personal computers or network computers. For purposes of this application, a network computer is any computer, coupled to a network, which receives a program or other application from another computer coupled to the network. In the depicted example, server 503 provides data, such as boot files, operating system images, and applications to clients 502, 504, and 506. Clients 502, 504, and 506 are clients to server 503.

According to another embodiment, said Academic core banking system 500 may include additional servers, clients, and other devices not shown. In the depicted example, distributed data processing system 500 is the Internet with network 501 representing a worldwide collection of networks and gateways that use the TCP/IP suite of protocols to communicate with one another. At the heart of the Internet is a backbone of high-speed data communication lines between major nodes or host computers that route data and messages. Of course, distributed data processing system 500 also may be implemented as a number of different types of networks, such as for example, an intranet or a local area network.

FIG. 5 is intended as an example, and not as an architectural limitation for the processes of the present invention.

### FIG. 6—Application Architecture

In one embodiment, as described in FIG. 6, the compensation application is implemented using a highly scalable, service oriented architecture having a user interface that utilizes a rich graphical user interface application and a high performance back end that utilizes standard relational databases. FIG. 6 shows a high level representation of the academic banking application architecture 600 used in one embodiment of an academic core banking system.

The application has three primary tiers; a user interface tier 603 based on arithmetic logic circuits configured to retrieve information from a specific file sources, calculate incremental modifications based on specific input, allocate the results and store output in separate files, an application tier 602 and a database tier 601. The use of a multi-tiered distributed application allows various parts of the application to operate on different devices.

According to another embodiment, the user interface tier 603 also provides user interface screens for the client computers and receives data input from the client computers. The application tier 602 includes a business layer that supports client services and implements business logic functions of the application. The application tier 602 also includes a database abstraction layer that functions as a bridge between the business layer and the database tier 601. In one embodiment, the function of the database layer 601 is database independent. The database layers translate data to and from value objects used by the business layer and data objects used by the data adapter layer of the database tier 601.

The database tier 601 includes a database adapter layer that formats data from the data abstraction layer in database dependent format. As shown in FIG. 6, in one embodiment, the academic banking architecture 600 is operable with Oracle database systems, SQL Server database systems as well as others.

### Additional Considerations

Throughout this specification, plural instances may implement components, operations, or structures described a single instance. Although individual operations of one or more methods are illustrated and described as separate operations' one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, nonvolatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for academic core banking through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### CONCLUSION & SCOPE

Accordingly, the reader will see that the present invention discloses methods and systems for academic institutional banking that provide a highly reliable, scalable yet economical solution that can be used by various academic institutions. The modules in the present invention are highly integrated but loosely coupled, so institutions can easily replace modules, rules, or services without affecting core code.

Insubstantial changes from the claimed subject matter as viewed by a person with ordinary skill in the art, now known or later devised, are expressly contemplated as being equivalently within the scope of this disclosure. Persons skilled in the art could appreciate that steps of the process discussed herein can be omitted, modified, combined, or rearranged, and any additional steps can be performed without departing from the scope of the invention. Therefore, obvious substitutions now or later known to one with ordinary skill in the art are defined to be within the scope of the defined elements.

While various embodiments have been described above, it should be understood that they have been presented by way of example only, and not limitation. For example, any of the elements associated with the academic core banking system may employ any of the desired functionality set forth hereinabove. Thus, the breadth and scope of a preferred embodiment should not be limited.

Furthermore, the scope of the invention should be determined by the appended claims and their legal equivalents, rather than by the examples given.

1. A high bandwidth, scalable enterprise computer system architecture for storing, retrieving, and transporting financial transaction data to one or more clients in one or more networked academic core banking processing systems, said enterprise computer system architecture comprising:
a debt bank interface configured to issue bonds, notes and other forms of indebtedness and generate the unrestricted revenue funds from the restricted revenue funds or operating assets; and;
an asset bank interface configured to manage liquidity across an institution; and
a general ledger module configured to leverage unrestricted revenue funds into a multitude of financial instruments,

2. The enterprise computer system architecture recited in claim 1, wherein the general ledger module is configured to segment operating assets into a polarity of layers of liquidity.

3. The enterprise computer system architecture recited in claim 1, wherein the asset bank interface is configured to pool working capital and calculate blended interest rates.

4. The enterprise computer system architecture recited in claim 1, wherein the general ledger module is configured to process loan requests, issue loans, and track loans.

5. The enterprise computer system architecture recited in claim 1, wherein said debt bank interface is configured to generate net interest margins from re-loaning bond funds.

6. The enterprise computer system architecture recited in claim 5, further comprising business domains configured to underwrite bond issuance, monitor new and outstanding obligations, and sell bonds through a public financing operation.

7. The enterprise computer system architecture recited in claim 1, wherein said general ledger module is configured to preclude co-mingling of said unrestricted revenue funds and operating working capital reserves.

8. The enterprise computer system architecture recited in claim 1, wherein said debt bank interface determines borrower blended interest rates based on external cost of capital plus administrative and interest rate buffers;

9. The enterprise computer system architecture recited in claim 8, further comprising means for calculating borrower blended interest rates consisting of variable interest rates reflecting short-term borrowing cost.

10. A non-transitory computer readable medium storing computer executable instructions that, when executed, cause one or more processors of a computer system to perform:
issuing bonds, notes and other forms of indebtedness, and generating the unrestricted revenue funds from the restricted revenue funds or operating assets; and
managing liquidity and establishing interest rates; and
leveraging unrestricted revenue reserves into a multitude of financial instruments; and
displaying dashboards, alerts, analytics and delivering qualitative and quantitative information in the required dimensionality.

11. The computer readable medium recited in claim 10, wherein the computer executable instructions generate net interest margins from re-loaning bonds or other restricted funds.

12. The computer readable medium recited in claim 10, wherein said computer executable instructions pool working capital and determine net interest margins from investing in capital markets.

13. The computer readable medium recited in claim 10, wherein said computer executable instructions facilitates mobile and person-to-person payments.

14. The computer readable medium recited in claim 10, wherein said computer executable instructions develop loan structures independent of funding sources, processes loan requests, issues loans, generates amortization schedule for loans, tracks loans, displays capital and liquidity metrics and provides reporting formats.

15. The computer readable medium recited in claim 10, wherein said computer executable instructions compiles said unrestricted revenue funds into a polarity of stabilization layers.

16. An academic core banking method for managing, storing, retrieving, transporting financial transaction data, comprising:
issuing bonds, notes and other forms of indebtedness, and generating the unrestricted revenue funds from the restricted revenue funds or operating assets; and
managing liquidity and establishing interest rates; and
leveraging unrestricted revenue reserves into a multitude of financial instruments; and
displaying dashboards, alerts, analytics and delivering qualitative and quantitative information in the required dimensionality; and
compiling said unrestricted revenue funds into a polarity of layers.

17. The academic core banking method recited in claim 16, further comprising generating net interest margins from re-loaning bonds or other restricted funds.

18. The academic core banking method recited in claim 16, further comprising pooling working capital and establishing interest rates.

19. The academic core banking method recited in claim 16, further comprising providing processes of booking, disbursements, and payments.

20. The academic core banking method recited in claim 19, further comprising facilitating mobile and person-to-person payments.
